(19) United States
(12) Patent Application Publication
(10) Pub. No.: US 2003/0131342 A1
(43) Pub. Date: Jul. 10, 2003

(54) Debugger with activity alert

(75) Inventors: Cary Lee Bates, Rochester, MN (US); John Matthew Santosuosso, Rochester, MN (US)

Correspondence Address: Gero G. McClellan, Moser, Patterson & Sheridan, L.L.P., Suite 1500, 3040 Post Oak Boulevard, Houston, TX, 77056-6582, US

(73) Assignee: International Business Machines Corporation, Armonk, NY

(21) Appl. No.: 10/041,159

(22) Filed: Jan. 8, 2002

(51) Int. Cl. G06F 9/44

(52) U.S. Cl. 717/125; 717/110

(57) ABSTRACT

Method, apparatus and article of manufacture for examining and debugging code. In general, code is displayed on a display device formatted to indicated historical information and/or real-time information. In one embodiment, code modification information for a code portion is programmatically generated, wherein the code modification information reflects at least one change made to the code portion with respect to a previous version of the code portion. The code portion is then displayed on a display device during a debugging session; and the code modification information is visually represented on the display device while displaying the code portion. In another embodiment, a method comprises displaying, on a display device of a computer, at least one of a name and activity of at least one other user currently accessing the code portion from the at least one other computer.

### BACKGROUND OF THE INVENTION

1. Field of the Invention

The present invention generally relates to data processing. More particularly, the invention relates to debugging.

2. Description of the Related Art

A programmer develops a software program by producing and entering source code into files using a text editor program. The computer then creates an executable program by translating the source code into machine code. The machine code is the rudimentary instructions understood by a computer. Illustratively, the foregoing software development process is accomplished by running a series of programs. These programs typically include a compiler for translating the source code into machine code and a linker to link the machine code together to form a program.

When developing computer software, it is necessary to perform a function termed “debugging”. Debugging involves testing and evaluating the software to find and correct any errors and improper logic operation. An effective debugger program is necessary for rapid and efficient development of software.

A conventional debugging system comprises a combination of computer hardware and debugger software that executes a user's program in a controlled manner. Debugging aids a user in identifying and correcting mistakes in an authored program by allowing the program to be executed in small segments.

In today's large-scale software development projects, multiple users often work together as members of a team. In this kind of collaborative group environment each user operates in an integrated development environment (IDE) which facilitates editing, compiling and debugging. Group development promotes economies of scale by allowing users to share code. While providing many advantages, group development makes it necessary to employ some form of management to ensure integrity of the code. To this end, some group development environments incorporate features such as library controls which require parts (i.e., code) to be checked in and checked out. Code which has been checked out by a user is not available for modification by any other user, thereby ensuring that only a single copy of the code is being modified at any given time.

In addition to ensuring the integrity of code, group development environments must provide users with meaningful information about the code. Consider, for example, a situation in which a user debugging a problem manifesting itself in the user's code steps into a routine owned and maintained by another user. The visiting user debugging the problem usually tries to determine which lines of code have changed in order to determine whether the changes are likely to have caused the problem. Such information may be provided in the form of change flags which exist in comments. In general, a flag is associated with a particular line of code and provides an index into the header comments, which provides detailed information about the particular line of containing the change.

One problem with the use of change flags is its reliance on the discipline and judgment of the programmers maintaining the code. In some cases, a programmer may feel that a change they have made is insignificant and does not merit a flag. In other cases, a programmer may simply fail to add a flag even where significant changes are made. As a result, users visiting other programmers' code are afforded little confidence in the information provided in the form of flags and headers. Furthermore, conventional approaches provide no means of letting users know what others are currently doing with a given piece of code.

Therefore, there is a need for a system and method for providing users meaningful information about code in a development environment, and particularly in a debugging environment.

### SUMMARY OF THE INVENTION

The present invention generally provides methods, apparatus and articles of manufacture for examining and debugging code. One embodiment provides a method of debugging code comprising programmatically generating code modification information for a code portion, wherein the code modification information reflects at least one change made to the code portion with respect to a previous version of the code portion. The code portion is then displayed on a display device during a debugging session; and the code modification information is graphically represented on the display device while displaying the code portion.

Another embodiment provides a computer readable medium containing a program which, when executed during a debugging session, performs an operation comprising retrieving programmatically generated code modification information for a code portion and graphically representing the code modification information on the display device while displaying the code portion. The code modification information reflects at least one change made to the code portion with respect to a previous version of the code portion. In various embodiments, the program may be a debugger and/or a part of an integrated development environment.

In yet another embodiment a computer system comprises a display device a memory containing at least a debug program; and a processor operably connected to the display device and the memory and which, when executing the debug program, is configured to perform an operation. In one embodiment, the operation comprises retrieving programmatically generated code modification information for a code portion and graphically representing the code modification information on the display device while displaying the code portion. The code modification information reflects at least one change made to the code portion with respect to a previous version of the code portion. In one embodiment, the computer system further comprises a repository from which the code portion is retrieved and wherein the code portion includes modifications made by multiple users. The programmatically generated code modification information may be generated when the code portion is checked into the repository by comparing the code portion being checked in to the previous version of the code portion. In another embodiment, the computer system further comprises a network connection configured to support communication with a plurality of computers and wherein the operation performed by the processor further comprises graphically representing at least one of an activity and position of at least one other user currently accessing the code portion from one of the plurality of computers.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a high-level diagram of network environment including at least one computer configured for debugging.

FIG. 2 is a representation of one embodiment of a change control table.

FIG. 3 is a representation of one embodiment of a position data table.

FIG. 4 is a flowchart illustrating a check-in routine.

FIG. 5 is a flowchart illustrating the operation of a debugger.

FIGS. 6-7 are representations of graphical user interfaces (GUIs) illustrating graphical formatting techniques for identifying historical and real-time information pertaining to code.

### DETAILED DESCRIPTION OF THE PREFERRED EMBODIMENTS

The present invention generally provides methods, apparatus and articles of manufacture for debugging code. In general, code displayed on a display device formatted to indicated historical information and/or real-time information.

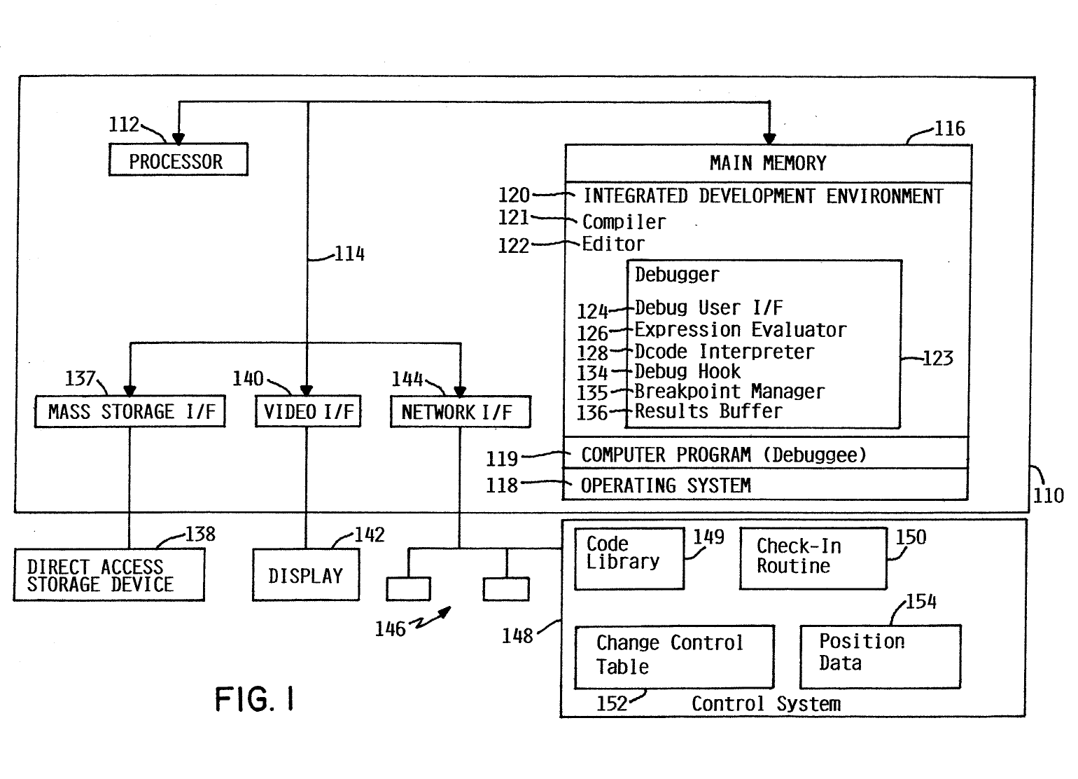

One embodiment of the invention is implemented as a program product for use with a computer system such as, for example, the computing environment shown in FIG. 1 and described below. The program(s) of the program product defines functions of the embodiments (including the methods described below) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Referring now to FIG. 1, a distributed environment 100 is shown. computer system 110 consistent with the invention is shown. In general, the distributed environment 100 includes a computer system 110 and a plurality of networked devices 146. For simplicity, only the details of the computer system 110 are shown. However, it is understood that the computer system 110 may be representative of one or more of the networked devices 146. In general, computer system 110 and the networked devices 146 could be desktop or PC-based computers, workstations, network terminals, or other networked computer systems. Illustratively, the networked devices 146 include a control system 148 which may be a file server or database, for example. In any case, the control system 148 maintains a library of code 149 which may be shared between users of the networked environment 100. The library of code 149 is managed by controls such as a check-in routine 150 which is invoked each time code is checked in to the library 149. When executed, the routine 150 creates a record in a change control table 152 for each range of the code that was modified. In addition, the control system 148 includes a position data table 154. Embodiments of the change control table 152 and the position data table 154 are described below.

Computer system 110 may represent any type of computer, computer system or other programmable electronic device, including a client computer, a server computer, a portable computer, an embedded controller, etc. Although shown networked into a larger system, the computer system 110 may be a standalone device. Moreover, those skilled in the art will appreciate that embodiments may be practiced with other computer system configurations including hand-held devices, multiprocessor systems, microprocessor-based or programmable consumer electronics, minicomputers, mainframe computers and the like. The embodiment may also be practiced in distributed computing environments in which tasks are performed by remote processing devices that are linked through a communications network. In a distributed computing environment, program modules may be located in both local and remote memory storage devices. In this regard, the computer system 110 and one or more of the networked devices 146 may be thin clients which perform little or no processing. In a particular embodiment, the computer system 110 is an eServer iSeries 400 computer available from International Business Machines, Corporation of Armonk, N.Y.

The computer system 110 could include a number of operators and peripheral systems as shown, for example, by a mass storage interface 137 operably connected to a direct access storage device 138, by a video interface 140 operably connected to a display 142, and by a network interface 144 operably connected to the plurality of networked devices 146. The display 142 may be any video output device for outputting viewable information.

Computer system 110 is shown comprising at least one processor 112, which obtains instructions, or operation codes, (also known as opcodes), and data via a bus 114 from a main memory 116. The processor 112 could be any processor adapted to support the debugging methods, apparatus and article of manufacture of the invention. In particular, the computer processor 112 is selected to support the debugging features of the present invention. Illustratively, the processor is a PowerPC available from International Business Machines Corporation of Armonk, N.Y.

The main memory 116 is any memory sufficiently large to hold the necessary programs and data structures. Main memory 116 could be one or a combination of memory devices, including Random Access Memory, nonvolatile or backup memory, (e.g., programmable or Flash memories, read-only memories, etc.). In addition, memory 116 may be considered to include memory physically located elsewhere in a computer system 110, for example, any storage capacity used as virtual memory or stored on a mass storage device or on another computer coupled to the computer system 110 via bus 114.

As shown, the main memory 116 generally includes an operating system 118, a computer program 119 and an Integrated Development Environment (IDE) 120. The computer program 119 represents any code that is to be examined, edited, compiled and/or debugged. The IDE 120 comprises a compiler 121, an editor 122 and a debugger program (the debugger) 123. The IDE 120 is merely illustrative and in another embodiment, an interpreter is provided instead of the compiler 121, for example. More generally, the IDE 120 provides any combination of tools for editing, compiling and locating, analyzing and correcting faults. In one embodiment, the IDE 120 is a VisualAge for C++ for OS/400 IDE modified according to the invention. VisualAge for C++ for OS/400 is available from International Business Machines, Corporation of Armonk, N.Y.

Although the software constructs, such as the computer program 119 and the debugger 123, are shown residing on the same computer, a distributed environment is also contemplated. Thus, for example, the debugger 123 may be located on a networked device 146, while the computer program 119 to be debugged is on the computer system 110.

In a specific embodiment, the debugger 123 comprises a debugger user interface 124, expression evaluator 126, Dcode interpreter 128 (also referred to herein as the debug interpreter 128), debugger hook (also known as a stop handler) 134, a breakpoint manager 135 and a results buffer 136. Although treated herein as integral parts of the debugger 123, one or more of the foregoing components may exist separately in the computer system 110. Further, the debugger may include additional components not shown.

A debugging process is initiated by the debug user interface 124. The user interface 124 presents the program under debugging and highlights the current line of the program on which a stop or error occurs. The user interface 124 allows the user to set control points (e.g., breakpoints and watch points), display and change variable values, and activate other inventive features described herein by inputting the appropriate commands. In some instances, the user may define the commands by referring to high-order language (HOL) references such as line or statement numbers or software object references such as a program or module name, from which the physical memory address may be cross referenced.

The expression evaluator 126 parses the debugger command passed from the user interface 124 and uses a data structure (e.g., a table) generated by a compiler to map the line number in the debugger command to the physical memory address in memory 116. In addition, the expression evaluator 126 generates a Dcode program for the command. The Dcode program is machine executable language that emulates the commands. Some embodiments of the invention include Dcodes which, when executed, activate control features described in more detail below.

The Dcode generated by the expression evaluator 126 is executed by the Dcode interpreter 128. The interpreter 128 handles expressions and Dcode instructions to perform various debugging steps. Results from Dcode interpreter 128 are returned to the user interface 124 through the expression evaluator 126. In addition, the Dcode interpreter 128 passes on information to the debug hook 134, which takes steps described below.

After the commands are entered, the user provides an input that resumes execution of the program 120. During execution, control is returned to the debugger 123 via the debug hook 134. The debug hook 134 is a code segment that returns control to the appropriate user interface. In some implementations, execution of the program eventually results in an event causing a trap to fire (e.g., a breakpoint or watchpoint is encountered). Control is then returned to the debugger by the debug hook 134 and program execution is halted. The debug hook 134 then invokes the debug user interface 124 and may pass the results to the user interface 124. Alternatively, the results may be passed to the results buffer 136 to cache data for the user interface 124. In other embodiments, the user may input a command while the program is stopped, causing the debugger to run a desired debugging routine. Result values are then provided to the user via the user interface 124.

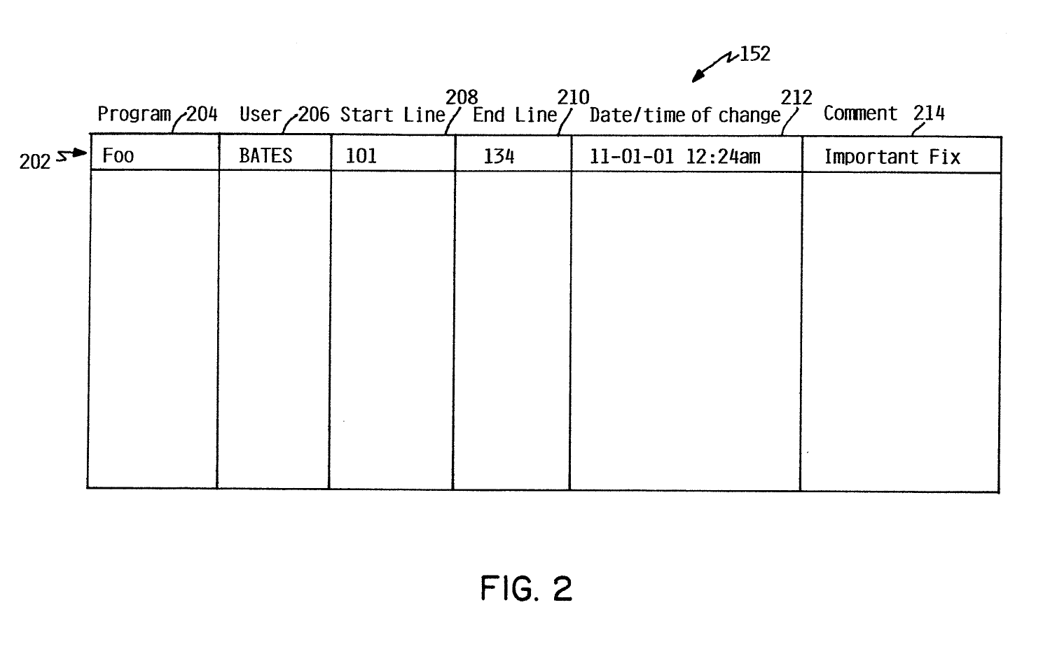

FIG. 2 shows one embodiment of the change control table 152. In general, the change control table 152 is organized as a plurality of columns and rows, where each row defines a record. For simplicity, only a single record 202 is shown. The record 202 generally describes changes that were made to code by a particular user. The code may be a program, a module, a routine, a method, a class, a header or any other code portion, whether executable or not. The code to which changes were made is identified in a code column 204. The portion of the affected code is specified as a range having its beginning identified in a start line column 208 and its end identified in an end line column 210. The user responsible for the changes is identified in a user column 206. A “date/time of change” column 212 contains date and time stamps indicating when the changes were made. In one embodiment, the change control table 152 includes a comment column 214 which is configured to contain comments provided by the user.

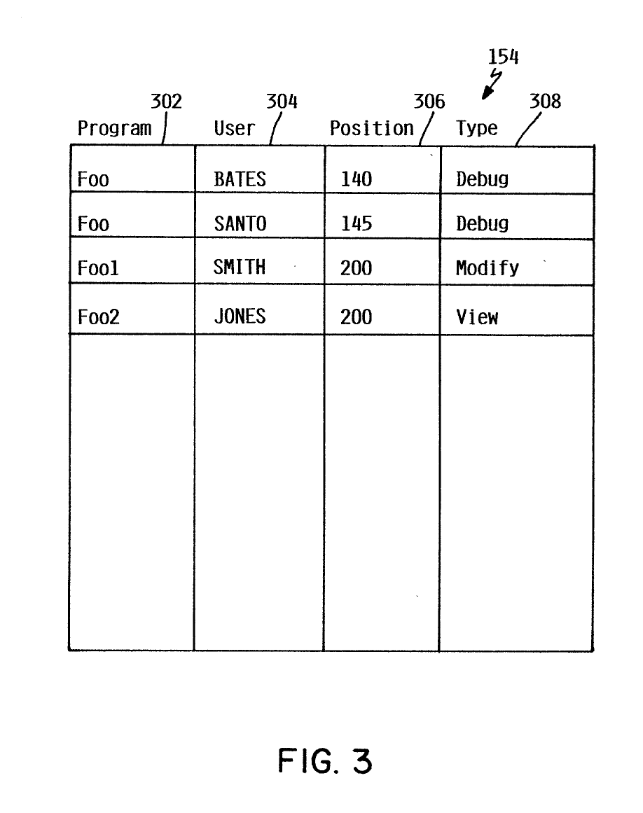

FIG. 3 shows one embodiment of the position data table 154. The position data table 154 is organized as a plurality of columns and rows, where each row defines a record. In general, each record is specific to a particular user and provides information about the user's current activity. The user for each record is specified in a user column 304, while the program which the user is currently accessing is indicated in a program column 302. A position column 306 specifies a stop position for the user of the record. In the case of users currently involved in debugging code, the stop position indicates that position at which execution of the user's program was last stopped (e.g., as a result of a breakpoint, run-to-cursor, step, etc.). In the case of users currently involved in editing code or viewing code, the stop position indicates, for example, a cursor position. The nature of a user's activity with respect to the code (e.g., debugging, editing and viewing) is specified in a type column 308.

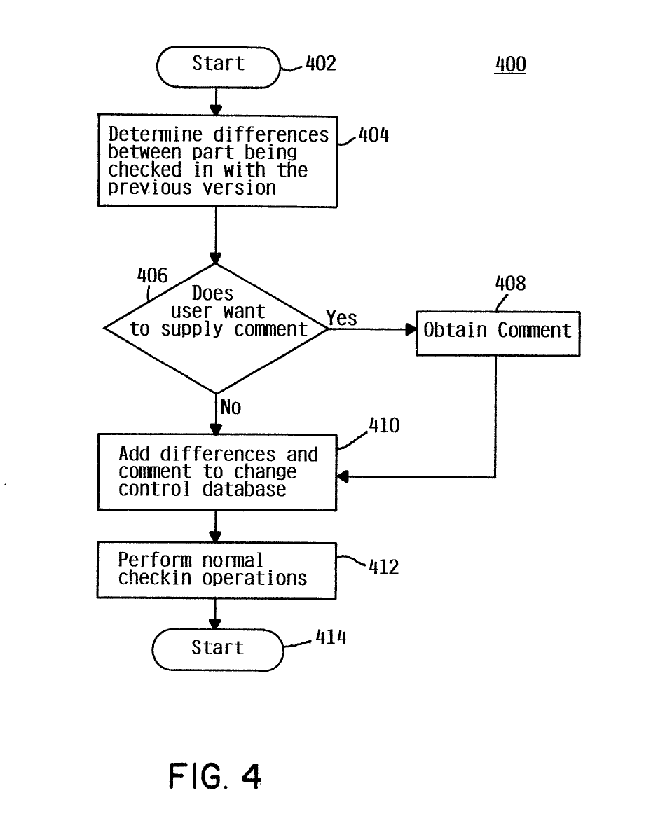

Referring now to FIG. 4 an instance of a method 400 performed by the check-in routine 150 shown. As noted above, the check-in routine 150 is invoked when a user returns (i.e. checks in) a program that was previously checked out. The method 400 is entered at step 402 and proceeds to step 404 to determine the differences between the program being checked in with the previous version of the program (located in the library 149). Processing then proceeds to step 406 where the method queries whether the user desires to supply a comment. If so, the comment is obtained at step 408. If no comment is supplied, or after the comment is obtained at step 408, processing proceeds to step 410 where the method 400 adds a record to the change control table 152 indicating the differences (determined at step 404) and the comment (if any). At step 412, normal check-in operations are performed. For example, the program being checked in is returned to the library 149. The method 400 then exits at step 414.

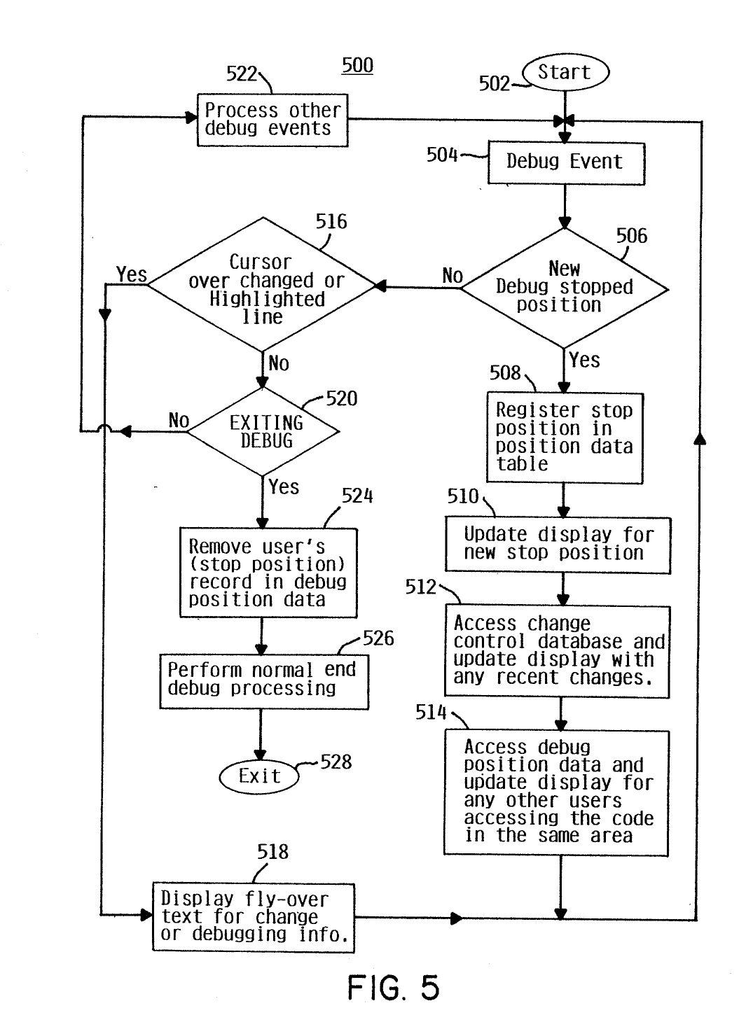

Referring now to FIG. 5, a method 500 is shown illustrating the operation of the debugger 123 during a debugging session. It should be noted that while the code which is the subject of a debugging session may (at one time) have been checked in by the check-in routine 150, the user performing the debugging (method 500) need not be the same user who checked in the code (method 400).

The method 500 is entered at step 502 and proceeds to step 504 to receive a debug event for processing. At step 506, the method 500 queries whether the debug event is to handle a new debug stop position. A new debug stop position may be encountered, for example, when a breakpoint is encountered. If step 506 is answered affirmatively, the stop position is registered in the position data table 154 at step 508. At step 510, the user's display is updated according to the current stop position. Updating the display may include highlighting the line of code at which execution stopped.

At step 512 and 514, steps are taken to provide the user with meaningful information pertaining to the code being viewed on the display. For example, at step 512 the change control table 152 is accessed to retrieve records specific to the displayed code portion. The relevant records may be identified according to the entries in the code column 204, the start line column 208 and the end line column 210. The records from the change control table 152 are then used to update the source code being viewed by the user on the display device. Specifically, the records are used to graphically indicate the most recent changes to the code being viewed. By “graphically” is meant any manner of formatting (whether by text, images, colors, font, italics, bowls, etc.) which visually conveys code modification information to the user.

While the modification information provided by the change control table 152 provides historical information, the position data table 154 provides real-time information. Accordingly, the position data table 154 is accessed at step 514 to retrieve any relevant records. In this case, relevant records include all records pertaining to the code portion being viewed by the user. A determination of which records are relevant can be made with reference to the entries in the program column 302 and the position column 306 of the position data table 154. Once retrieved, the relevant records are used to graphically indicate the activity of other users within the code portion being viewed by the current user (i.e., the user for whom the method 500 is being executed). Again, embodiments of the intention are not limited to the particular manner in which the graphical indications are made.

Once the code portion being displayed has been updated with the historical information provided by the change control table 152 and the real-time information provided by the position data table 154, the method 500 returns to step 504 to begin processing the next event. If the event being processed is not a new debug stop position then processing proceeds from step 506 to step 516.

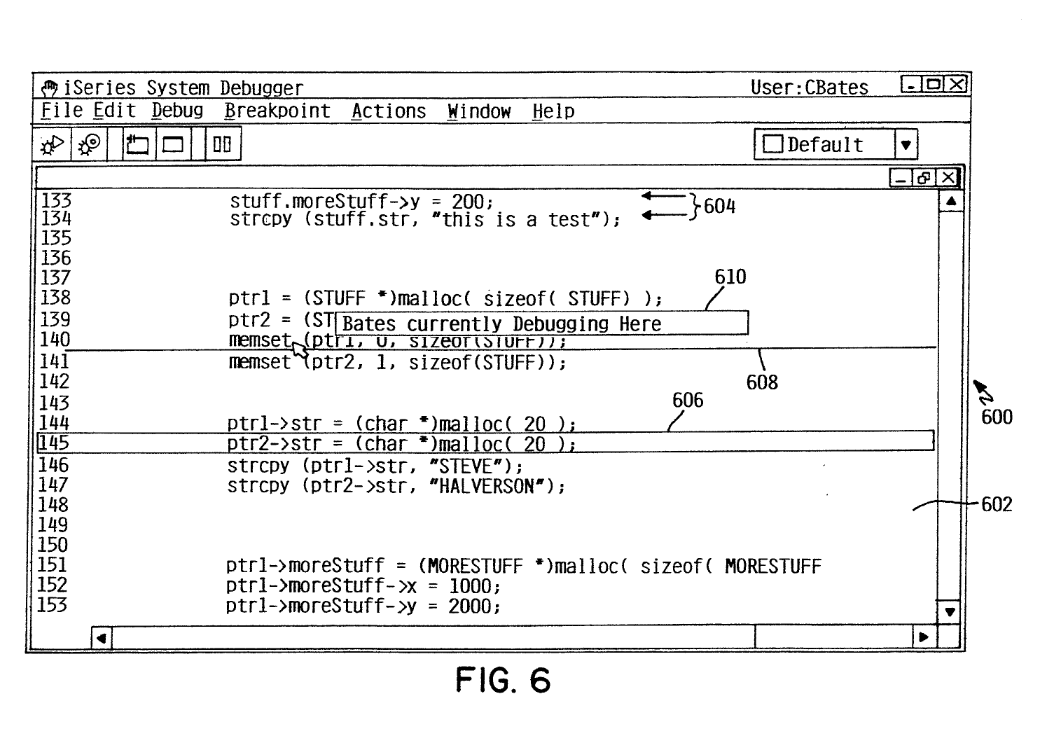

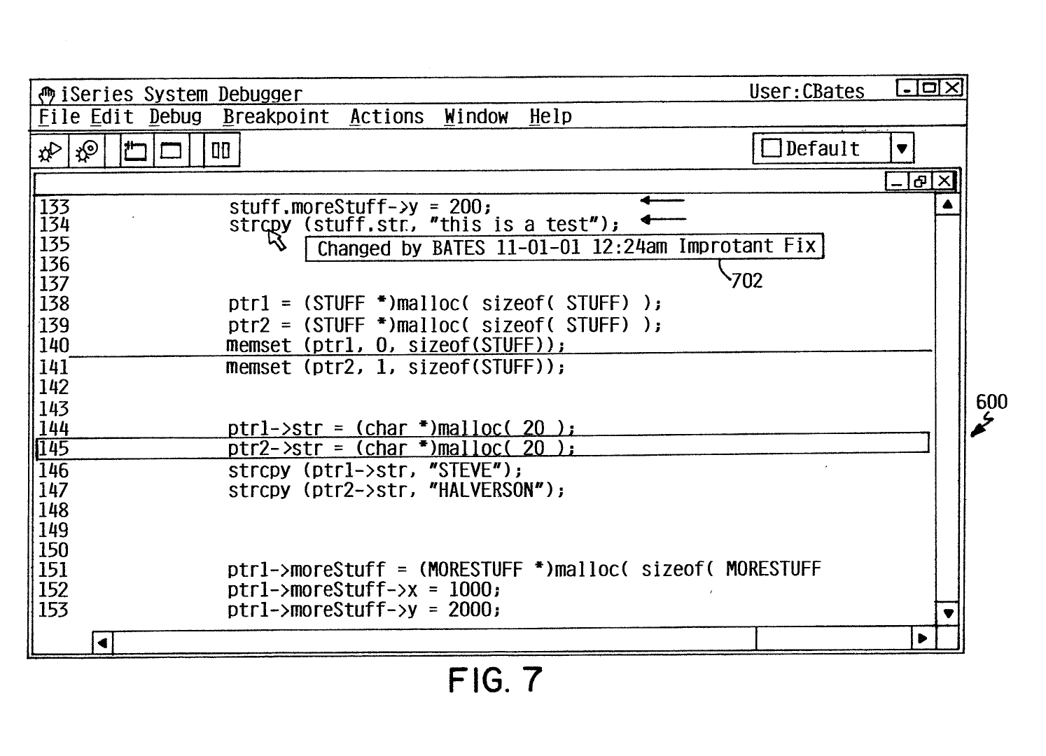

At step 516, the method 500 queries whether the cursor is over a modified or highlighted line. If so, some form of a textual annotation is displayed at step 518. For example, in the case of modified code, a user comment contained in the comment column 214 for the relevant record of the change control table 152 may be displayed. Alternatively, if the cursor is currently positioned on a code line at which another user is stopped, then the annotation may be used to indicate this fact. In one embodiment, the annotation may be displayed as fly-over text. Examples of graphical formatting and annotation will be described below with reference to FIGS. 6 and 7.

If step 516 is answered negatively, processing proceeds to step 520. At step 520, the method 500 queries whether the user is exiting the debugger 123. If not, the method 500 proceeds to step 522 to process other events. If, however, the user is exiting the debugger, then processing proceeds to step 524 where the user's record is removed from the position data table 154. Normal exiting procedures are performed at step 526, after which the method 500 is exited at step 528.

Examples of the manner in which source code may be formatted to indicate historical information as well as real-time information will now be described with reference to FIGS. 6 and 7. Referring first FIGS. 6, an instance of a graphical user interface (GUI) 600 is shown. The GUI 600 is illustrative of the debug user interface 124 (described above with reference to FIG. 1) when rendered on an output device such as the display 142 (also described above with reference to FIG. 1). In general, the GUI 600 defines a viewable screen area 602 in which source code is displayed. The source code is formatted by various graphical techniques, each of which convey meaningful information to a user viewing the source code in the screen area 602. For example, lines 133 and 134 include arrows 604 indicating that the respective code has been modified. In one embodiment, the arrows 604 indicate a modification within some predetermined period of time. In another embodiment, the arrows 604 indicate a modification since the last time the user viewing the screen area 602 accessed the code contained therein.

The GUI 600 is also formatted to indicate the current position of each user at some location within the displayed source code. The current position may correspond to a stop position during a debug session or a cursor position in the case of users who are editing source code, for example. Illustratively, the positions for two users are shown. One of the users is the user viewing the screen area 602 (referred to herein as the local user) and is identified by a box 606 at line 145. The other user is a remote user located elsewhere on a system. The position for the remote user is indicated by underlining 608, at line 140. The identity of the remote user can be ascertained by positioning the cursor on the line of code at which the remote user is stopped, thereby invoking a fly-over text box 610. In addition to providing the identity of surmount user the text box 610 also provides a brief description of the remote user's activity.

Using the cursor, text boxes for any of the highlighted or modified code may be displayed. For example, FIG. 7 shows the cursor located on the source code at line 134, thereby displaying a fly-over text box 702. As described above, the source code at line 134 is identified as modified source code by the presence of the arrow 604. The particular details of the modification, including any comments, are contained within the fly-over text box 702.

The foregoing embodiments are merely illustrative and persons skilled in the art will recognize other implementations within the scope of the invention. For example, in one embodiment, local users may select a group of remote users of interest. Thus, only the remote users in the predefined group would be monitored and made known to the local user (e.g., in the fly-over text). This may be particularly desirable in environments having a large number of remote users. In still another embodiment, a user may select a particular line (or portion) of code of interest (e.g., by setting a watch on the code) and be notified of any remote users accessing the selected code. In this way, the user is notified of on-going activity with respect to the selected code even when the user is not currently viewing the code.

While the foregoing is directed to embodiments of the present invention, other and further embodiments of the invention may be devised without departing from the basic scope thereof, and the scope thereof is determined by the claims that follow.

What is claimed is:

1. A method of debugging code, the method comprising:
programmatically generating code modification information for a code portion, wherein the code modification information reflects at least one change made to the code portion with respect to a previous version of the code portion;
displaying the code portion on a display device during a debugging session; and
visually representing the code modification information on the display device while displaying the code portion.

2. The method of claim 1, wherein the code modification information is visually represented to a first user other than a second user responsible for the at least one change.

3. The method of claim 1, wherein programmatically generating code modification information comprises:
determining, when the code portion is being checked into a library, a difference between the code portion and the previous version of the code portion; and
recording the difference.

4. The method of claim 1, wherein visually representing the code modification information comprises displaying code modification information specific to a particular line of code of the code portion in a form of textual annotation.

5. The method of claim 4, wherein displaying the textual annotation comprises displaying fly-over text.

6. The method of claim 4, wherein displaying the textual annotation comprises displaying a comment provided by a user responsible for the at least one change.

7. The method of claim 1, further comprising visually representing at least one an activity of at least one other user currently accessing the code portion and a position of the at least one other user currently accessing the code portion.

8. The method of claim 7, wherein visually representing activity of the at least one other user comprises indicating on the display device a current stop position of the at least one other user.

9. A computer readable medium containing a program which, when executed during a debugging session, performs an operation comprising:
retrieving programmatically generated code modification information for a code portion, wherein the code modification information reflects at least one change made to the code portion with respect to a previous version of the code portion; and
visually representing the code modification information on the display device while displaying the code portion.

10. The computer readable medium of claim 9, wherein the program is a debug program.

11. The computer readable medium of claim 9, wherein the program is a component of an integrated development environment.

12. The computer readable medium of claim 9, wherein the programmatically generated code modification information is generated when the code portion is checked into a library and by comparing the code portion being checked in to the previous version of the code portion.

13. The computer readable medium of claim 9, wherein visually representing the code modification information comprises displaying code modification information specific to a particular line of code of the code portion in a form of textual annotation.

14. The computer readable medium of claim 13, wherein displaying the textual annotation comprises displaying fly-over text.

15. The computer readable medium of claim 13, wherein displaying the textual annotation comprises displaying a comment provided by a user responsible for the at least one change.

16. The computer readable medium of claim 9, further comprising visually representing activity of at least one other user currently accessing the code portion.

17. The computer readable medium of claim 16, wherein visually representing activity of the at least one other user comprises indicating on the display device a current stop position of the at least one other user.

18. A computer readable medium containing a program which, when executed while debugging a code portion during a debugging session on a computer networked to at least one other computer, performs an operation comprising:
visually representing, on a display device of the computer, at least one of a name and activity of at least one other user currently accessing the code portion from the at least one other computer.

19. The computer readable medium of claim 18, wherein visually representing the code portion occurs when a watch, set on the code portion, fires in response to the at least one other user accessing the code portion.

20. The computer readable medium of claim 18, further comprising:
visually representing code modification information on the display device of the computer.

21. The computer readable medium of claim 18, wherein the at least one other user is identified in a data structure containing a user-defined user group comprising users of interest.

22. The computer readable medium of claim 18, wherein visually representing activity of the at least one other user comprises indicating on the display device a current stop position of the at least one other user.

23. The computer readable medium of claim 18, wherein displaying the name comprises displaying fly-over text.

24. A computer system, comprising:
a display device;
a memory containing at least a debug program; and
a processor operably connected to the display device and the memory and which, when executing the debug program, is configured to perform an operation comprising:
retrieving programmatically generated code modification information for a code portion, wherein the code modification information reflects at least one change made to the code portion with respect to a previous version of the code portion; and
visually representing the code modification information on the display device while displaying the code portion.

25. The computer system of claim 24, further comprising a repository from which the code portion is retrieved and wherein the code portion includes modifications made by multiple users.

26. The computer system of claim 25, wherein the programmatically generated code modification information is generated when the code portion is checked into the repository by comparing the code portion being checked in to the previous version of the code portion.

27. The computer system of claim 24, wherein visually representing the code modification information on the display device comprises displaying code modification information specific to a particular line of code of the code portion in a form of textual annotation.

28. The computer system of claim 27, wherein displaying the textual annotation comprises displaying a comment provided by a user responsible for the at least one change.

29. The computer system of claim 24, further comprising a network connection configured to support communication with a plurality of computers and wherein the operation performed by the processor further comprises visually representing at least one of an activity and a position of at least one other user currently accessing the code portion from one of the plurality of computers.
